(19) United States
(12) Patent Application Publication
(10) Pub. No.: US 2026/0274339 A1
(43) Pub. Date: Sep. 17, 2026

(54) MODULAR FRAME FOR A VEHICLE

(71) Applicant: BHARAT FORGE LIMITED, Pune (IN)

(72) Inventors: Babasaheb Neelkanth KALYANI, Pune (IN); Jitendra Madhusudan PATIL, Pune (IN); Mohammad Siraj Mohammad Gous SHAIKH, Pune (IN); Vishal Vitthal GAIKWAD, Pune (IN); Pratiksha Shashikant CHALKE, Pune (IN)

(73) Assignee: BHARAT FORGE LIMITED, Pune (IN)

(21) Appl. No.: 19/568,343

(22) Filed: Mar. 16, 2026

(30) Foreign Application Priority Data
Mar. 17, 2025 (IN) 202521023357

(51) Int. Cl. B62D 21/12; B62D 63/02

(52) U.S. Cl. CPC B62D 21/12; B62D 63/025

(57) ABSTRACT

The present disclosure provides a modular frame for a vehicle. The modular frame includes a subframe, a main body, a plurality of metal plates, a plurality of first joining means. Further, the subframe includes a first vertical interface. Furthermore, the main body includes a second vertical interface. In addition, the main body and the subframe are configured to mount on a vehicle chassis. Further, at least one metal plate from the plurality of metal plates is joined onto the first vertical interface and the second vertical interface. Moreover, the main body and the subframe are connected to each other by the first vertical interface and the second vertical interface via the plurality of first joining means.

### CROSS-REFERENCE TO RELATED APPLICATIONS AND PRIORITY

The present application claims priority from Indian Patent Application no. 202521023357 filed on 17 Mar. 2025

### TECHNICAL FIELD

The present disclosure relates to the field of vehicle assembly and, in particular, relates to a modular frame for a vehicle.

### BACKGROUND

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Vehicle structural integrity represents a critical engineering challenge, particularly in high-stress environments such as military and security applications. The fundamental problem lies in the inherent vulnerabilities of traditional vehicle body designs when subjected to extreme external forces. Conventional vehicle frames, especially unibody designs where the frame and body are integrated into a single structure, demonstrate significant structural weaknesses under dynamic and high-impact loading conditions.

One primary concern is vehicle body drooping, a critical issue that emerges when vehicles are exposed to severe mechanical stresses. In military and security contexts, high-velocity impacts like gunfire and/or heavy accessories can cause substantial deformation of the vehicle's body structure. Such deformation compromises not only the vehicle's aesthetic integrity but, more critically, its operational capabilities.

The weight distribution problem further complicates vehicle frame design and performance. Traditional unibody constructions struggle to manage load distribution effectively, particularly when heavy equipment or significant external loads are introduced. As vehicles traverse uneven terrain or encounter sudden shock loads, the integrated frame-body structure can experience progressive deformation. This ongoing stress can lead to permanent structural warping, reducing the vehicle's long-term reliability and performance.

Manufacturing complexity represents another substantial challenge in current vehicle frame technologies. Attempting to balance strength, durability, and weight within a single, integrated structure requires sophisticated engineering approaches. The need to create a frame that can simultaneously resist drooping, manage heavy loads, and maintain structural integrity across diverse operational environments presents significant design constraints. Traditional manufacturing techniques often struggle to achieve this delicate balance without compromising one structural attribute in favor of another.

In light of the foregoing discussion, there exists a need for an advanced structural approach which can address at least one of the above discussed requirements.

### SUMMARY

Before the present system and method and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present disclosure. This summary is not intended to identify essential features of the claimed subject matter nor is it intended for use in detecting or limiting the scope of the claimed subject matter.

According to a first aspect of the present disclosure, a modular frame for a vehicle is disclosed. The modular frame includes a subframe, a main body, a plurality of metal plates, a plurality of first joining means. Further, the subframe includes a first vertical interface. Furthermore, the main body includes a second vertical interface. In addition, the main body and the subframe being configured to mount on a vehicle chassis. Further, at least one metal plate from the plurality of metal plates is joined onto at least one of the first vertical interface and the second vertical interface. Moreover, the main body and the subframe are connected to each other through the first vertical interface and the second vertical interface via the plurality of first joining means.

In an embodiment of the first aspect, the subframe and the main body are detachably connected to each other.

In another embodiment of the first aspect, the subframe and the main body are mounted on the vehicle chassis using second joining means.

In yet another embodiment of the first aspect, joining of the at least one metal plate from the plurality of metal plates onto the at least one of the first vertical interface and the second vertical interface being performed by at least one of welding, brazing, and adhesive.

In yet another embodiment of the first aspect, each of the first vertical interface and the second vertical interface includes a plurality of first holes on at least two extreme sides.

In yet another embodiment of the first aspect, each of the plurality of metal plates include a plurality of second holes. In addition, each of the plurality of second holes is positioned such that its center is aligned along a common axis with center of corresponding hole from the plurality of first holes. Further, the plurality of first joining means is configured to pass through the plurality of first holes and the plurality of second holes for connection of the subframe and the main body.

In yet another embodiment of the first aspect, the at least one metal plate from the plurality of metal plates is made from material selected from at least one of metal alloy, iron, steel, aluminum, titanium, or any combination thereof.

In yet another embodiment of the first aspect, the plurality of first joining means includes at least one of nuts, bolts, rivets, screws, circlips, pins, magnetic coupling, electromagnetic coupling, or any combination thereof.

In yet another embodiment of the first aspect, a plurality of sensors is provided in a proximity to at least one the first vertical interface and the second vertical interface. In addition, the plurality of sensors includes at least one of proximity sensors, crack detection sensor, vibration sensor, strain gauge sensor, temperature sensor, or any combination thereof.

In yet another embodiment of the first aspect, a display unit is provided which is configured to present the sensor data received from the plurality of sensors. Further, the display unit is configured to generate at least one of visual alerts, audible alerts, or haptic alerts based on the sensor data satisfying a predefined criterion.

According to a second aspect of the present disclosure, server for remotely monitoring a modular frame of a vehicle. Further, the server includes one or more processors and one or more memory units for storing computer-useable instructions that, when used by the one or more processors, cause the one or more processors to perform operations including the first step of receiving sensor data from a plurality of sensors provided in a proximity to at least one of a first vertical interface and a second vertical interface. In addition, the sensor data is wirelessly transmitted from a communication module of the modular frame. Further, the second of detecting a movement and a degree of attachment integrity of at least one of at least one of a first vertical interface, a second vertical interface, a plurality of metal plates, and a plurality of first joining means of the modular frame based on the sensor data. Furthermore, the third step of determining a risk level associated with the movement and the degree of attachment integrity based on one or more pre-defined thresholds. Subsequently, the fourth step of generating a status report including the movement, the attachment integrity, the risk level of at least one of the first vertical interface, the second vertical interface, the plurality of metal plates, and the plurality of first joining means. Moreover, the fifth step of providing the status report to one or more users for remotely monitoring of the modular frame of the vehicle.

In an embodiment of the second aspect, the risk level includes low risk level, medium risk level, and high risk level which represents a severity of potential failure of at least one of the first vertical interface, the second vertical interface, the plurality of metal plates, and the plurality of first joining means based on the movement and the degree of attachment integrity.

### BRIEF DESCRIPTION OF FIGURES

Having thus described the disclosure in general terms, references will now be made to the accompanying figures, wherein:

FIG. 1 illustrates first perspective view of a modular frame for a vehicle, in accordance with various embodiments of the present disclosure;

FIG. 2 illustrates top view of the modular frame for the vehicle, in accordance with various embodiments of the present disclosure;

FIG. 3 illustrates side view of the modular frame for the vehicle, in accordance with various embodiments of the present disclosure;

FIG. 4 illustrates a second perspective view which shows a connection between a subframe and a main body, in accordance with various embodiments of the present disclosure; and

FIG. 5 illustrates a block diagram which shows a server for remotely monitoring the modular frame of the vehicle, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Reference will now be made in more detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects of embodiments of the present description. As used herein, the term “and/or” includes any and all combinations of one or more of the associated listed items. Throughout the present disclosure, the expression “at least one of a, b and c” indicates only a, only b, only c, both a and b, both a and c, both b and c, all of a, b, and c, or variations thereof.

The subject matter of the present disclosure may include various modifications and various embodiments, and example embodiments will be illustrated in the drawings and described in more detail in the detailed description. Effects and features of the subject matter of the present disclosure, and implementation methods therefore will become clear with reference to the embodiments described herein below together with the drawings. The subject matter of the present disclosure may, however, be embodied in many different forms and should not be construed as limited to the embodiments set forth herein.

Hereinafter, embodiments of the present disclosure will be described in more detail with reference to the accompanying drawings. The same or corresponding elements will be denoted by the same reference numerals, and thus, redundant description thereof will not be repeated.

It will be understood that although the terms “first,” “second,” etc. may be used herein to describe various elements, these elements should not be limited by these terms. These terms are only used to distinguish one element from another.

An expression used in the singular may also encompasses the expression of the plural, unless it has a clearly different meaning in the context.

In the following embodiments, it is to be understood that the terms such as “including,” “includes,” “having,” “comprises,” and “comprising,” are intended to indicate the existence of the features or elements disclosed in the specification, and are not intended to preclude the possibility that one or more other features or elements may exist or may be added.

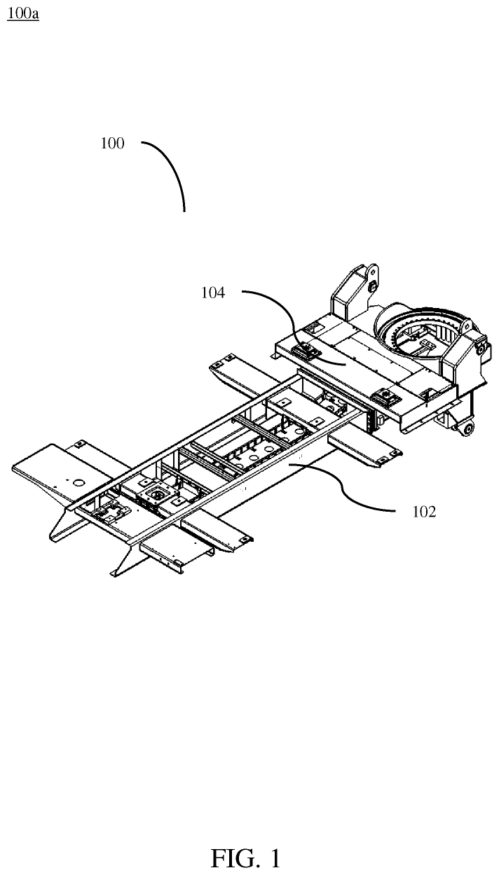

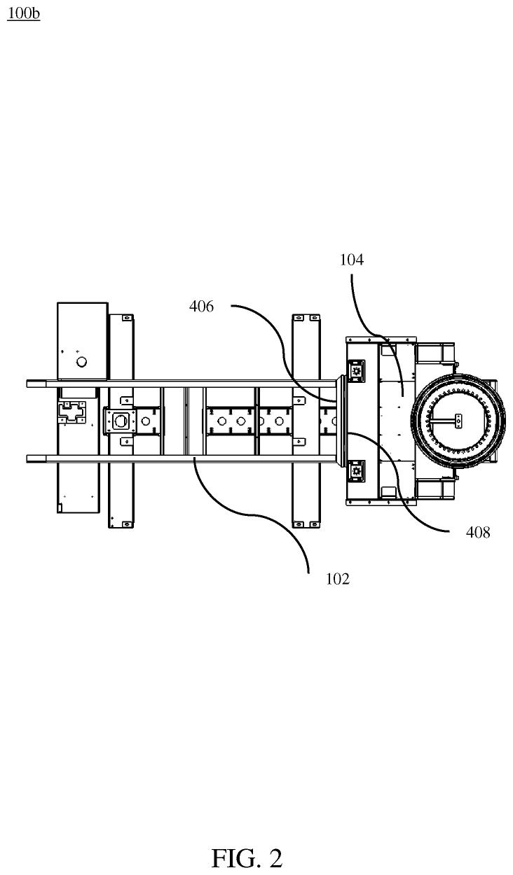

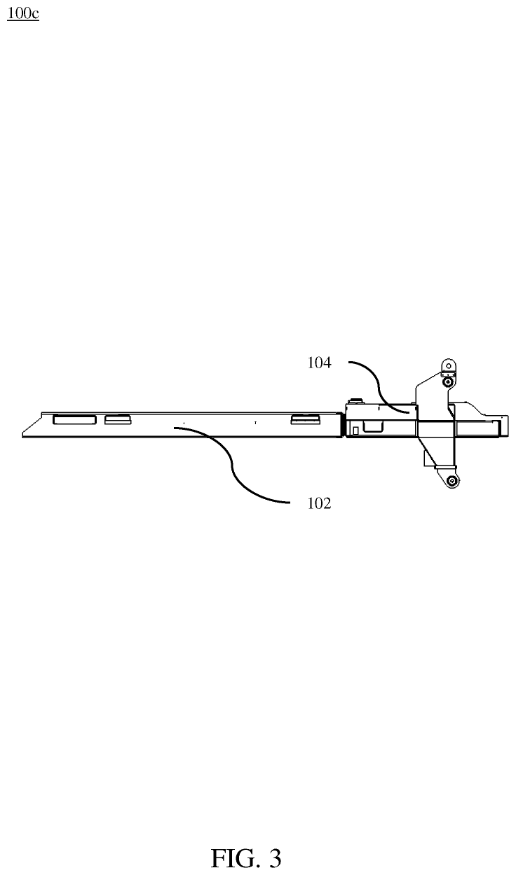

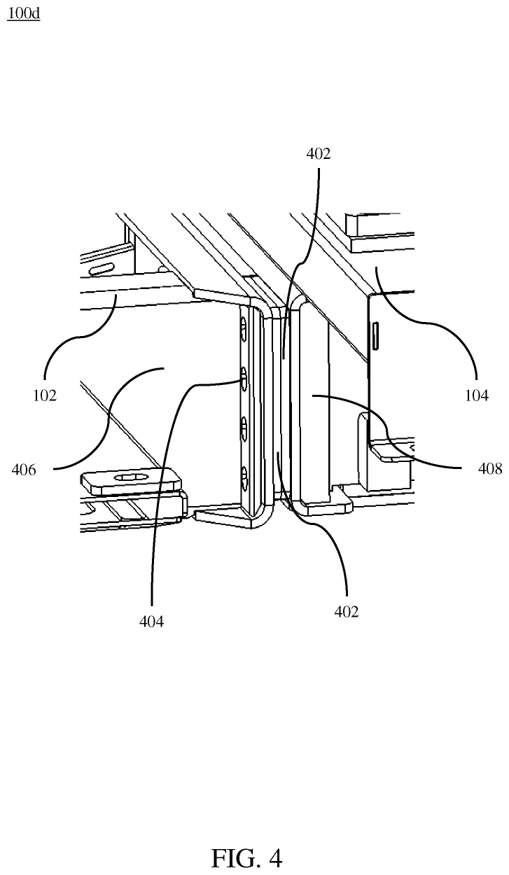

FIG. 1 illustrates first perspective view (100a) of a modular frame (100) for a vehicle, in accordance with various embodiments of the present disclosure. FIG. 2 illustrates top view (100b) of the modular frame (100) for the vehicle, in accordance with various embodiments of the present disclosure. FIG. 3 illustrates side view (100c) of the modular frame (100) for the vehicle, in accordance with various embodiments of the present disclosure. FIG. 4 illustrates a second perspective view (100d) which shows a connection between a subframe (102) and a main body (104), in accordance with various embodiments of the present disclosure. In an embodiment of the present disclosure, the modular frame (100) for the vehicle is disclosed. The modular frame (100) includes the subframe (102), the main body (104), a plurality of metal plates (402), a plurality of first joining means (404).

In an aspect, the subframe (102) includes a first vertical interface (406). In addition, the main body (104) includes a second vertical interface (408). Further, the main body (104) and the subframe (102) being configured to mount on a vehicle chassis. Furthermore, at least one metal plate from the plurality of metal plates (402) is joined onto at least one of the first vertical interface (406) and the second vertical interface (408). Moreover, the main body (104) and the subframe (102) are connected to each other through the first vertical interface (406) and the second vertical interface (408) via the plurality of first joining means (404).

In an example embodiment, the subframe (102) and the main body (104) may be detachably mounted on the vehicle chassis. In some embodiments, the subframe (102) and the main body (104) are detachably connected to each other. Further, the subframe (102) and the main body (104) may be mounted on the vehicle chassis using second joining means. In addition, the second joining means may include one or more flexible mounts. Further, the one or more flexible mount may include chassis bracket and subframe bracket. In addition, the chassis bracket is connected to the chassis of the vehicle and subframe bracket is connected to the subframe (102) of the vehicle. Moreover, the one or more flexible mounts may include nuts, bolts, rivets, screws, circlips, pins, magnetic coupling or any combination thereof.

In another example embodiment, the joining of the at least one metal plate from the plurality of metal plates (402) onto the first vertical interface (406) and the second vertical interface (408) may be performed by welding, brazing, adhesives, and the like. In addition, the adhesives may be epoxy adhesives, polyurethane adhesives, acrylic adhesives, metal bonding adhesives, or any combination thereof. In some examples, the joining of the two metal plates onto the vertical interface may be done by brazing.

In yet another example embodiment, the first vertical interface (406) and the second vertical interface (408) may include a plurality of first holes on at least two extreme edges. Furthermore, the plurality of metal plates (402) may include a plurality of second holes. In an embodiment, each of the plurality of second holes is positioned such that its center is aligned along a common axis with center of corresponding hole from the plurality of first holes. In addition, the plurality of first joining means (404) may be configured to pass through the plurality of first holes and the plurality of second holes for precise connection of the subframe (102) and the main body (104).

In yet another example embodiment, the at least one metal plate from the plurality of metal plates (402) may be made from material selected from at least one of metal alloy, iron, steel, aluminum, titanium, or any combination thereof. Furthermore, the plurality of first joining means (404) may include at least one of nuts, bolts, rivets, screws, circlips, pins, magnetic coupling, or any combination thereof. In some examples, the two frames may be joined together by using the magnetic coupling.

In some implementations, the modular frame (100) for the vehicle may include a plurality of sensors (208) positioned in proximity to at least one of the first vertical interface (406) and the second vertical interface (408). In an example, the plurality of sensors (208) may include at least one of proximity sensor for detecting presence of structural elements, crack detection sensor for identifying material discontinuities, vibration sensor for monitoring structural movement, strain gauge sensor for measuring mechanical stress, temperature sensor for detecting thermal anomalies in frame connections, and the like. In another example, the plurality of sensors (208) may be configured to detect the presence of cracks in the plurality of metal plates (402) forming part of the modular frame (100). In yet another example, the plurality of sensors (208) may be configured to monitor the condition of the first joining means (404) and the second joining means, including detecting any loosening or detachment of these joining components. In yet another example, the plurality of sensors (208) may be configured to detect unusual or abnormal movement between the subframe (102) and the main body (104) of the vehicle, which could indicate structural issues or failures.

In some embodiments, feedback (may also referred as sensor data) from the plurality of sensors (208) may be processed and relayed through an engine control unit (ECU) of the vehicle. Further, the ECU may be configured to provide real-time feedback to the vehicle's operator. In an embodiment, a display unit is provided which is configured to present feedback (or data) received from the plurality of sensors (208). Furthermore, the feedback may be displayed on the display unit integrated into the vehicle's instrumentation control panel, enabling the operator to be immediately informed of any detected issues related to the modular frame (100), such as cracks, loosening of joints, or any unusual movements. In some embodiments, the display unit is configured to generate at least one of visual alerts, audible alerts, or haptic alerts based on the sensor data satisfying a predefined criterion. Additionally, the feedback may be displayed on a terminal or user interface, for example on a mobile device, providing real-time updates and alerts regarding the condition of the modular frame (100) regarding maintenance or repair actions.

In an example, the predefined criterion may include multi-factor analysis combining data from several sensors of the plurality of sensors (208) positioned near the first vertical interface (406) and the second vertical interface (408). In one example, when moderate readings from both strain gauge sensors and vibration sensors occur simultaneously, the display unit generates alerts before any single measurement becomes critical.

In some embodiments, visual alerts from the display unit may employ color-coded indicators showing affected areas of the subframe (102) and main body (104), while audible alerts may use distinct patterns for different issues. Further, haptic alerts may vary in intensity based on severity, ranging from gentle pulses for advisory notices to stronger vibrations for situations requiring immediate attention.

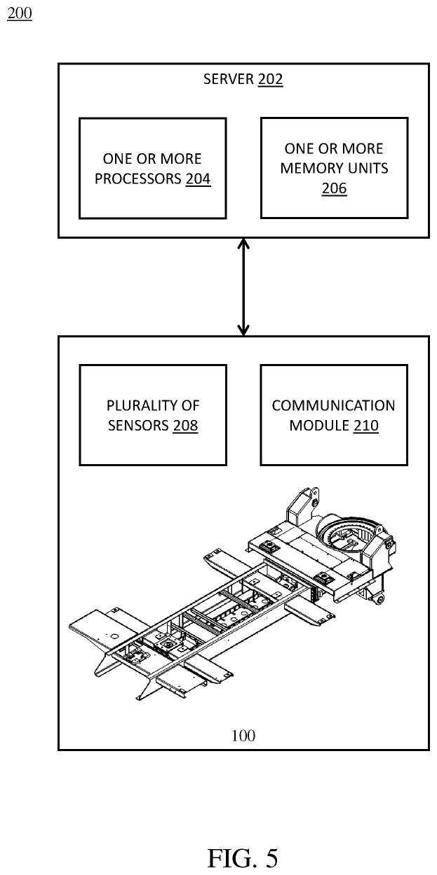

FIG. 5 illustrates a block diagram (200) which shows a server (202) for remotely monitoring the modular frame (100) of the vehicle, in accordance with various embodiments of the present disclosure. The server (202) includes one or more processors (204) and one or more memory units (206) for storing computer-useable instructions that, when used by the one or more processors, cause the one or more processors (204) to perform operations for monitoring the structural integrity of the modular frame (100). The operations include receiving sensor data from the plurality of sensors (208) positioned around the first vertical interface (406) and the second vertical interface (408) of the modular frame (100). The sensor data is wirelessly transmitted from a communication module (210) integrated within the modular frame (100) to the server (202).

Further, the server (202) performs analysis operations to detect movements and determine the degree of attachment integrity of critical components of the modular frame (100), including the first vertical interface (406), the second vertical interface (408), the plurality of metal plates (402), and the plurality of first joining means (404). The degree of attachment integrity refers to the condition and stability of connections between components of the modular frame (100). The condition and stability may include how securely the plurality of first joining means (404) are fastened, whether there is any loosening of bolts or nuts, whether there are any cracks in the plurality of metal plates (402), and whether the first vertical interface (406) and the second vertical interface (408) remain properly aligned and connected.

Based on the analysis performed on the sensor data, the server (202) determines a risk level associated with the detected movement and the degree of attachment integrity. The risk level includes categories of a low risk level, a medium risk level, and a high risk level representing severity of a potential failure of at least one of the first vertical interface (406), the second vertical interface (408), the plurality of metal plates (402), and the plurality of first joining means (404). In one embodiment, this risk level assessment is based on one or more pre-defined thresholds established through pre-performed engineering analysis, testing, and safety standards relevant to vehicle structural integrity.

In one example, the low risk level indicates that all components remain firmly connected as designed, with minimal to no movement at connection points. Further, the medium risk level indicates some minor loosening of joining means or slight misalignment of interfaces, while the high risk level indicates significant loosening, partial detachment, or structural damage to connection points that requires immediate attention.

In another example, the risk level provides clear guidance for maintenance actions. The low risk level typically indicates that the vehicle remains safe for normal operation but should be monitored during routine maintenance. The medium risk level suggests that while the vehicle can continue operation, maintenance should be scheduled in the near future to address the developing issues. The high risk level indicates potential safety concerns that require immediate attention, potentially including taking the vehicle out of service until repairs can be completed.

In some examples, the thresholds related to movements may be measured in millimeters (mm) in a scale of 0 to 10, where 0 represents no risk, a movement of 1 to 4 mm between the subframe (102) and the main body (104) may represent the low risk level, a movement of 5 to 7 mm may represent the medium risk level, and a movement of 8 to 10 mm or greater may represent the high risk level. Similarly, thresholds related to vibration sensing may be established for acceptable vibration amplitude and frequency ranges that correlate to the structural health of the modular frame (100).

For example, if the strain gauge sensor detects that a bolt in the plurality of first joining means (404) has loosened, causing a 3 mm movement between the subframe (102) and the main body (104), the server (202) may classify this as the low risk level. This low risk level indicates that while some movement is occurring, it remains within acceptable safety parameters. However, if the movement increases to 6 mm, the risk level may be elevated to the medium risk level, suggesting that maintenance should be scheduled soon. If the movement reaches or exceeds 8 mm, the high risk level indicates that immediate attention is required to prevent potential structural failure.

After determining the risk level, the server (202) generates a status report that includes detailed information about the detected movement, the attachment integrity assessment, and the corresponding risk level of the components of the modular frame (100). This status report may serve as a critical diagnostic tool for one or more users to understand the current structural condition of the vehicle's modular frame (100). In an example, the one or more users may include at least one of vehicle operators, maintenance personnel, fleet managers, and the like.

The server (202) then provides this status report to the one or more users through various interfaces, such as mobile applications, web dashboard, integrated vehicle information system, and the like. The provision of the status report, including the real-time data about the structural health of the vehicle, to the one or more users enables remote monitoring of the modular frame (100) without requiring physical inspection. In addition to the status report, the one or more users may further receive notifications about changes in risk levels and make informed decisions about maintenance scheduling or immediate intervention when necessary.

In an example implementation, a transportation company operating a fleet of vehicles equipped with the modular frame (100) may utilize the server (202) to monitor all vehicles simultaneously. The server (202) continuously receives sensor data from the plurality of sensors (208) via the communication module (210) of each vehicle and processes the sensor data to detect movement patterns and assess attachment integrity, determines risk levels based on the one or more pre-defined thresholds, and generates status reports that are accessible to fleet managers through a centralized dashboard. If any vehicle's modular frame (100) shows signs of increasing risk, the server (202) can automatically generate alerts, enabling proactive maintenance before critical failures occur.

Further, the modular frame (100) for the vehicle provides several technical advantages as follows but are not limited to:
The design allows for the easy detachment and reattachment of the subframe and main body. This feature simplifies repairs, upgrades, or modifications without requiring extensive rework on the entire vehicle.
The modular frame can accommodate a variety of vehicle designs and configurations, making it suitable for different types of vehicles and applications.
The ability to connect the subframe and main body using various joining methods (such as nuts, bolts, or rivets) streamlines the manufacturing process, which reduces production time and costs.
Joining metal plates to the vertical interfaces through techniques like welding or brazing the overall strength and load distribution of the frame.
Structural monitoring is achieved through a sensor system (proximity, crack detection, vibration, strain gauge, and temperature sensors) positioned near vertical interfaces (406, 408) to provide real-time structural health assessment.
Diagnostic capabilities are integrated through the communication module that wirelessly transmits the sensor data to the remote server, with the display unit generating visual, audible, and haptic alerts for immediate operator notification.
The modular frame can be easily adapted for various vehicle models or specifications, enabling manufacturers to meet diverse market demands without significant redesign efforts.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the scope of the present disclosure as defined by the following claims, and equivalents thereof.

1. A modular frame for a vehicle, wherein the modular frame comprising:
a subframe comprises a first vertical interface;
a main body comprises a second vertical interface, wherein the main body and the subframe being configured to mount on a vehicle chassis;
a plurality of metal plates, wherein at least one metal plate from the plurality of metal plates is joined onto at least one of the first vertical interface and the second vertical interface; and
a plurality of first joining means, wherein the plurality of first joining means connects the main body and the subframe to each other through the first vertical interface and the second vertical interface.

2. The modular frame as claimed in claim 1, wherein the subframe and the main body are detachably connected to each other.

3. The modular frame as claimed in claim 1, wherein the subframe and the main body are mounted on the vehicle chassis using a second joining means.

4. The modular frame as claimed in claim 1, wherein joining of the at least one metal plate from the plurality of metal plates onto the at least one of the first vertical interface and the second vertical interface being performed by at least one of welding, brazing, and adhesive.

5. The modular frame as claimed in claim 1, wherein each of the first vertical interface and the second vertical interface comprises a plurality of first holes on at least two extreme sides.

6. The modular frame as claimed in claim 5, wherein each of the plurality of metal plates comprises a plurality of second holes, wherein each of the plurality of second holes is positioned such that its center is aligned along a common axis with center of corresponding hole from the plurality of first holes, and wherein the plurality of first joining means is configured to pass through the plurality of first holes and the plurality of second holes for connection of the subframe and the main body.

7. The modular frame as claimed in claim 1, wherein the at least one metal plate from the plurality of metal plates is made from material selected from at least one of metal alloy, iron, steel, aluminum, titanium, or any combination thereof, and wherein the plurality of first joining means comprises at least one of nuts, bolts, rivets, screws, circlips, pins, magnetic coupling, electromagnetic coupling, or any combination thereof, and wherein the second joining means comprises a chassis bracket and a subframe bracket.

8. The modular frame as claimed in claim 1, comprises:
a plurality of sensors in a proximity to at least one the first vertical interface and the second vertical interface, wherein the plurality of sensors comprises at least one of proximity sensors, crack detection sensor, vibration sensor, strain gauge sensor, temperature sensor, or any combination thereof; and
a display unit configured to present the sensor data received from the plurality of sensors, wherein the display unit is configured to generate at least one of visual alerts, audible alerts, or haptic alerts based on the sensor data satisfying a predefined criterion.

9. A server for remotely monitoring a modular frame of a vehicle, wherein the server comprising:
one or more processors; and
one or more memory units storing computer-useable instructions that, when used by the one or more processors, cause the one or more processors to perform operations comprising:
receive sensor data from a plurality of sensors provided in a proximity to at least one of a first vertical interface and a second vertical interface, wherein the sensor data is wirelessly received from a communication module of the modular frame;
detect a movement and a degree of attachment integrity of at least one of the first vertical interface, the second vertical interface, a plurality of metal plates, and a plurality of first joining means of the modular frame based on the sensor data;
determine a risk level associated with the movement and the degree of attachment integrity based on one or more pre-defined thresholds; and
generate a status report comprising the movement, the attachment integrity, the risk level of at least one of the first vertical interface, the second vertical interface, the plurality of metal plates, and the plurality of first joining means.

10. The server as claimed in claim 9, wherein the risk level comprises a low risk level, a medium risk level, and a high risk level representing severity of a failure of at least one of the first vertical interface, the second vertical interface, the plurality of metal plates, and the plurality of first joining means, and wherein the failure is based on the movement and the degree of attachment integrity.
